(19) United States
(12) Patent Application Publication
(10) Pub. No.: US 2025/0257988 A1
(43) Pub. Date: Aug. 14, 2025

(54) SYSTEMS, DEVICES, AND METHODS FOR MEASURING CHARACTERISTICS OF MUSICAL INSTRUMENT STRINGS

(71) Applicant: GOTCHOPS MUSIC INC, New York, NY (US)

(72) Inventor: Shawn P. FERGUSON, New York, NY (US)

(73) Assignee: GOTCHOPS MUSIC INC, New York, NY (US)

(21) Appl. No.: 19/052,915

(22) Filed: Feb. 13, 2025

Related U.S. Application Data
(60) Provisional application No. 63/553,435, filed on Feb. 14, 2024.

(51) Int. Cl. G01B 3/20; G01B 5/02; G10D 3/14

(52) U.S. Cl. CPC G01B 3/20; G01B 5/02; G10D 3/14

(57) ABSTRACT

Systems and methods described herein relate to a string measurement system including a gauge body including a string opening configured to receive a string of an instrument. An electronic gauge is coupled to the gauge body, and is configured to: engage the string disposed in the string opening to measure a width of the string, and generate a first signal indicative of the width. The system may include a display configured to generate a display a width of the string. The electronic gauge may include a pair of calipers that are configured to engage the string of the instrument for determining a width of the string.

### CROSS-REFERENCE TO RELATED APPLICATIONS

This application claims priority to and the benefit of U.S. Provisional Patent Application No. 63/553,435, filed Feb. 14, 2024, and titled “SYSTEMS, DEVICES, AND METHODS FOR MEASURING CHARACTERISTICS OF MUSICAL INSTRUMENT STRINGS,”, the entire disclosure of which is incorporated herein by reference.

### TECHNICAL FIELD

Embodiments described herein relate to systems, devices, and methods for measuring or detecting one or more characteristics of musical instruments strings.

### BACKGROUND

String instruments are musical instruments that utilize the vibration of one or more strings to produce sound. During use, the strings can become worn out, damaged, or broken. Replacing strings involves choosing string gauges to achieve a desired sound from each string. However, the gauge, for example, width of the old string and/or the new string may not be known. This may result in inconsistent and/or undesirable sound associated with string replacement.

Traditional gauges are generally used for electrical wiring applications. These gauges are often designed for repeated use in settings where they may become damaged. Their rugged design can scratch the delicate surfaces of instruments. Moreover, manual reading of string gauge may result in inconsistencies that is undesirable.

### SUMMARY

Systems, devices, and methods described herein relate to an electronic string measurement system, and in particular, to a string measurement system that includes a gauge body an electronic gauge. The gauge body can include an opening configured to receive a string of an instrument. The electronic gauge can be disposed in or coupled to the gauge body. The electronic gauge may include calipers that are configured to engage the string disposed in the opening, and generate a signal indicative of the width of the string.

In some embodiments, a string measurement system includes a gauge body and an electronic gauge. The gauge body can include a string opening configured to receive a string of an instrument. The electronic gauge can be coupled to the gauge body, and can be configured to: engage the string disposed in the string opening to measure a width of the string, and generate a first signal indicative of the width.

In some embodiments, a string measurement system includes a gauge body, a set of calipers, a slider, and a position sensor. The gauge body can define a string opening configured to receive a string of a musical instrument. The set of calipers may be supported by the gauge body. The calipers can be configured to at least partially protrude into the string opening. The slider can be configured to enable movement of the set of calipers to cause at least a portion of the set of calipers to engage with a string positioned in the string opening. Further, the position sensor can be configured to determine position information associated with the calipers, the position information indicative of a width of the string positioned in the string opening.

In some embodiments, a string measurement system includes a gauge body, a position sensor, a tuner, a display, and a processor. The gauge body can define a string opening configured to receive a string of a musical instrument. The position sensor can be coupled to the gauge body. The tuner can be coupled to the gauge body. The display can be coupled to the gauge body. Further, the processor may be operably coupled to the position sensor and the tuner. The processor can be configured to: determine a width of the string based on position data received from the position sensor, determine an acoustic frequency associated with the string based on frequency data received from the tuner, and communicate a signal indicative of the determined width and the acoustic frequency to the display.

### BRIEF DESCRIPTION OF THE DRAWINGS

For a better understanding of the present technology, as well as other aspects and further features thereof, reference is made to the following description, which is to be used in conjunction with the accompanying drawings, where:

FIG. 1 is a schematic illustration of a system including a string measurement system for measuring and communicating a gauge of a string, according to an embodiment.

FIG. 2 is a schematic block diagram of an electronic gauge that may be included in the sting measurement system of FIG. 1, according to an embodiment.

FIG. 3 is an illustration of a string measurement system in a first configuration, according to an embodiment.

FIG. 4 is an illustration of the string measurement instrument of FIG. 3 in a second configuration, according to an embodiment.

FIG. 5 is an illustration of a string measurement system in a first configuration, according to an embodiment.

FIG. 6 is an illustration of a power source cover that may be included in any of the string measurement instruments described herein, according to an embodiment.

FIGS. 7A and 7B are illustrations of a power source cover removed from a string measurement instrument and being used as a manual gauge to measure a width of strings, according to an embodiment.

FIG. 8 is a schematic flow diagram of a method for determining a width of a string using a string measurement instrument, according to an embodiment.

FIG. 9 is a schematic flow diagram of a method for determining a frequency of string of a musical instrument using a string measurement system, according to an embodiment.

### DETAILED DESCRIPTION

Systems, devices, and methods described herein relate to an electronic string measurement system, and in particular, to a string measurement instrument that includes a gauge body including an opening configured to receive a string of an instrument, and an electronic gauge disposed in or coupled to the gauge body. The electronic gauge may include calipers that are configured to engage the string disposed in the opening, and generate a signal indicative of the width of the string. Embodiments described herein relate to systems and devices (e.g., electronic and/or manual gauges) and methods for measuring a characteristic (e.g., width, gauge, etc.) of a string (e.g., wire, etc.). In some embodiments, the systems and methods described herein are configured to measure strings for a musical instrument that utilizes strings to produce sound. For example, the musical instrument can be a guitar (e.g., classical guitar, acoustic guitar, electric guitar, bass guitar, baritone guitar, etc.), ukulele, banjo, violin, cello, contrabass, piano, harp, sitar, and/or the like. The systems and method described herein can be used to measure various types of strings, such as nylon strings, gut string, steel strings, and/or the like. Moreover, systems and methods described herein can also be used to measure a frequency of one or more strings included in such musical instruments.

Embodiments of the systems and methods described herein may provide one or more benefits including, for example: (1) allowing a user to rapidly and accurately determine a characteristic (e.g., a gauge, and/or width) of a string included in an instrument; (2) optionally, allowing a user to also measure a frequency of the instrument using the same instrument used to determine the characteristic of the string, to thereby allow the user to tune the frequency of the string to a desirable frequency; (3) optionally, including a manual gauge in the string measurement instrument, thus allowing a user to rapidly make manual string characteristic determination; and (4) optionally, enabling communication with a user device for displaying, logging, and/or storing the information related to the characteristic string of the instrument, for example, the string gauge, width, and/or frequency, or any other information related to the instrument or the user.

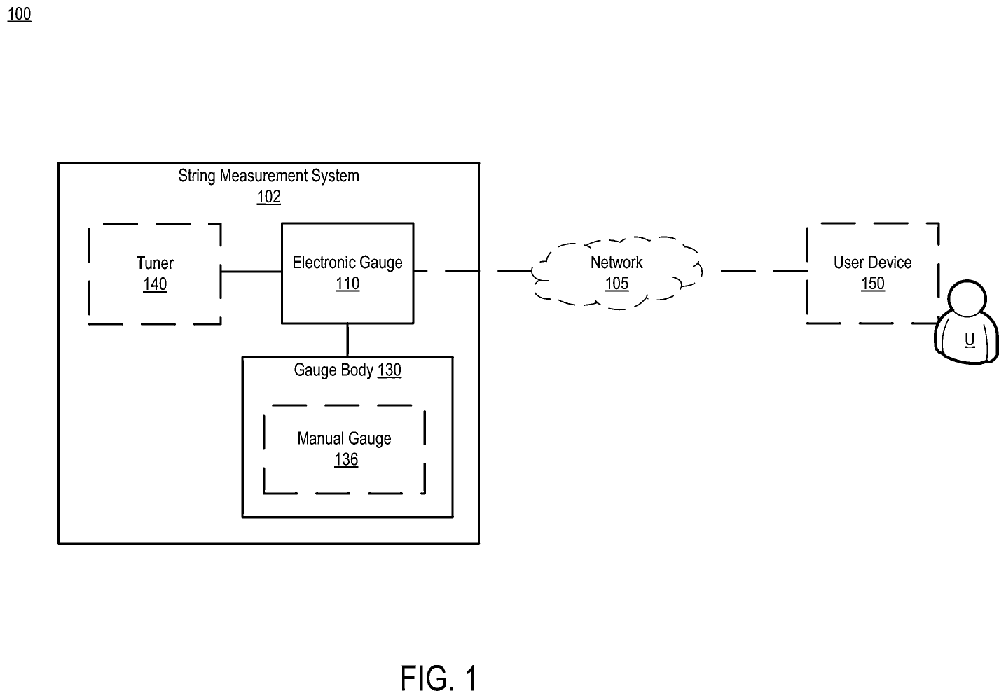

FIG. 1 is a schematic block diagram of a system 100 for measuring a characteristic of a string of a musical instrument (e.g., any of the musical instruments described herein), according to an embodiment. The system 100 may include a string measurement system 102 (also referred to herein as “system 102”), that may be communicatively coupled to a user device 150 associated with a user U via a network 105. The network 105 can include any suitable Local Area Network (LAN) or Wide Area Network (WAN). For example, the network 105 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network 105 is structured to permit the exchange of data, values, instructions, messages, and the like between the user device 150 and the string measurement system 102.

The user device 150 may include, for example a mobile phone (e.g., an iPHONE®, an ANDROID® phone, a WINDOWS® phone, a SYMBIAN® phone or the likes), a tablet computer, a personal computer (e.g., a desktop or a laptop), a smart TV, a smart watch, a gaming system, an IP TV box, or any other user device. The user device 150 may be configured to display and/or store one or more characteristics of a string of the musical instrument (e.g., gauge, width, frequency, etc.) received from the system 102, as described herein. For example, the user device 150 may be configured to store and launch an application associated with the system 102, which allows the user to view one or more characteristic of the strings of the musical instruments. The one or more characteristic(s) may be the one most recently measured by the system 102, or a log of the characteristics of one or more strings of the musical instrument measured over a predetermined time period (e.g., over one or more measurement sessions, measured in the last week, month, year, or since the first measurement was made). In some embodiments, the user device 150 may be configured to store the measured characteristic(s) locally on the user device 150 (e.g., on an onboard memory of the user device). In some embodiments, the user device 150 may be configured to store the measured characteristic(s) on a remote server or the cloud. In some embodiments, the user device 150 may also be configured to receive and store other information associated with the musical instrument such as, for example, the make and/or model of the musical instrument, name of the user, maintenance log, date when one or more strings changed, etc.

As shown in FIG. 1, the system 102 includes an electronic gauge 110 that is coupled to (e.g., disposed within) a gauge body 130 and configured to measure a characteristic, for example, a first characteristic, of one or more strings of the musical instrument (e.g., a gauge or width), according to an embodiment. In some embodiments, the system 102 may include a tuner 140 configured to measure a second characteristic of the one or more strings of the musical instrument that is different from the first characteristic, for example, a frequency of the one or more strings.

The gauge body 130 may include a housing that may have one more portions configured to be coupled together to define an internal volume within which at least a portion of the electronic gauge 110 may be disposed. In some embodiments, the gauge body 130 may be shaped as a guitar pick. For example, the gauge body 130 may have an oblong shape, an oval shape, a triangular shape, or an asymmetrical shape. In some embodiments, the gauge body 130 may have a proximate portion configured to be engaged (e.g., held or gripped) by a user, and a distal portion configured to engage the string of the instrument. In some embodiments, the proximate portion may have a first width that is larger than a second width of the distal portion. In other words, the proximate portion may be larger than the distal portion. In some embodiments, the gauge body 130 may have rounded corners and or edges, for example, to prevent damage such as scratches to the musical instrument, and/or the user when being used. For example, the gauge body 130 may be shaped as a rounded triangle with the proximate portion forming the base of the triangle and the tip forming the distal portion of the triangle. In some embodiments, the proximate portion may include engagement features, for example, grooves, indents, detents, ribs, etc., to enhance a grip of the user on the proximate portion. In some embodiments, at least the proximate portion and/or the distal portion may be formed from a soft material (e.g., plastics, rubberized plastic or metals, polymers, etc.) to facilitate gripping of the proximate portion, and/or inhibit damage to the musical instrument by the system 102 during use.

The gauge body 130 may include a string opening configured to receive a string of the instrument. For example, the string opening may include a slot or cut out defined in the distal portion of the gauge body 130. The string opening may be shaped or sized to receive a string of the instrument to allow the electronic gauge to measure a characteristic of the string of the instrument (e.g., a gauge or width). The string opening may have a sufficient width to accommodate or receive the largest width or diameter string of the musical instrument such that smaller width or diameter strings of the musical instrument can also be received into the string opening. For example, the string opening may have a width sufficient to receive each of strings E (6^{th} string), A (5^{th} string), D (4^{th} string), G (3^{rd} string), B (2^{nd} string), and E (1^{st} string) of a guitar. In some embodiments, edges or the corner of the string opening may be rounded, or formed, coated, and/or covered with a soft and flexible material to prevent damage to the musical instrument when the string is inserted into the string opening. For example, the user may grip the proximate portion of the gauge body 130, and dispose the distal portion of the gauge body on the musical instrument such that a target string of the musical instrument is received within the string opening.

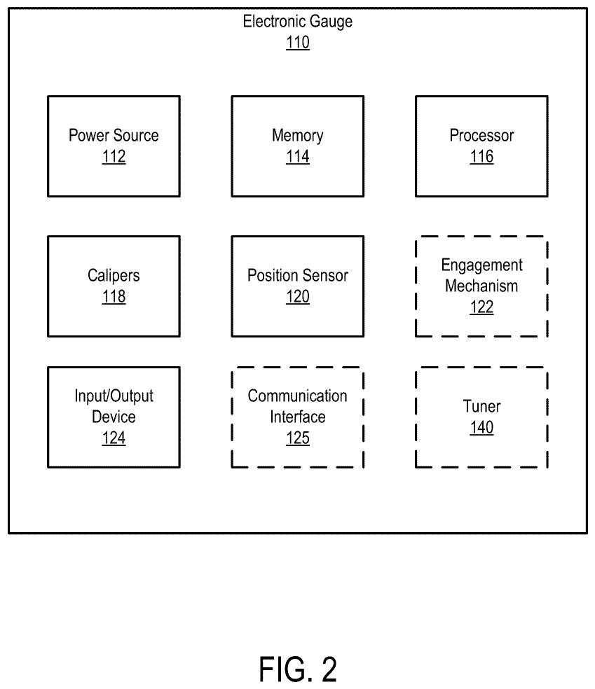

In some embodiments, the gauge body 130 may include one or more openings to allow various portions of the electronic gauge 110 to be viewable or engageable by the user U, as described herein. For example, the gauge body 130 may define a input/output opening through which an input/output device (e.g., an input/output device 224) of the electronic gauge 110, for example, a display may be viewable and/or engageable by the user U. In some embodiments, the gauge body 130 may define an engagement opening configured to allow the user to access an engagement mechanism (e.g., engagement mechanism 122 described with respect to FIG. 2) included in the electronic gauge 110 to enable measurement of the characteristic of the string of the musical instrument, as described herein.

In some embodiments, the gauge body 130 may also include a manual gauge 136. For example, a portion of the gauge body 130 may be configured to be used as a manual gauge to allow a user to manually measure a characteristic (e.g., a gauge or width) of the string of the instrument. In such implementations, a portion of the gauge body 130 may define a plurality of slot arranged around the perimeter of the portion of the gauge body 130. Each slot of the plurality of slots may define a width that is different from the width of the other slots of the plurality of slots. Each slot may be configured to receive a string of an instrument having a width that is less than or equal to the width of the respective slot. The user U can engage the slots with instrument strings to determine an approximate width or gauge of the instrument string. The widths of the plurality of slots can correspond to width or gauges of strings that are commonly grouped together for a particular instrument, such as in standard instrument gauges, gauges used by a particular musician, and/or the like.

In some embodiments, the plurality of slots may be defined in edges of the gauge body 130, for example, edges of the proximate portion and configured to serve as a manual gauge. In some embodiments, the gauge body 130 may include a power source opening configured to receive a power source (e.g., one or more coin cells, AA battery, AAA battery, D cell, rechargeable battery, etc.). In some embodiments, the manual gauge 136 may include a cover of the power source opening. For example, the power source opening may include a circular opening configured to receive a coin cell for providing electrical power to the electronic gauge 110, and the manual gauge 136 may include a circular cover configured to engage and close the power source opening. In such embodiments, the plurality of slots may be defined around a periphery of the manual gauge 136. For example, the user U can remove the manual gauge 136 from the gauge body 130 to access the power source and/or to use the manual gauge 136 for manually measuring the characteristic of the string of the instrument. In some embodiments, the manual gauge 136 may include any suitable manual gauge described in U.S. Provisional Application No. 63/520,567, filed Aug. 18, 2023, and entitled “Devices and Methods for Measuring Musical Instrument Strings,” the entire disclosure of which is incorporated herein by reference and attached hereto as Exhibit A.

In some embodiments, the gauge body 130 and/or the electronic gauge 110 may include a locking mechanism configured to selectively couple the system 102 to the musical instrument. For example, the gauge body 130 may include a clip (e.g., a guitar clip such as a capo used to change a pitch of guitar strings by locking on and shortening strings of the guitar), a latch, a lock, fasteners, or any other suitable coupling mechanism to couple the gauge body 130 to a portion of the musical instrument. In some embodiments, a portion of the gauge body 130 may be shaped as a capo or include a capo fixed or removably coupled thereto, and configured to be coupled to a neck of a guitar to adjust its pitch. In this manner, the system 102 can be used for measuring one or more characteristics of the guitar as well as a capo to adjust a pitch of the guitar or any other string musical instrument.

The electronic gauge 110 is configured to engage the string disposed in the string opening to measure a width of the string, and generate a first signal indicative of the width. In some embodiments, the electronic gauge 110 may include a pair of calipers. At least one of the pair of calipers may be configured to be moved relative to the other of the pair of calipers to receive and engage the string disposed in the string opening therebetween. For example, a tip of the calipers may extend into the string opening, while proximate ends of the calipers may be disposed in an internal volume defined by the gauge body 130. The proximate end of at least one of the calipers may be coupled to a position sensor 220 that is configured to generate the first signal, for example, a current or voltage indicative of the spacing between the tip of the calipers. When the string is disposed in the string opening of the gauge body 130 and the calipers are disposed such that inner edges of the calipers touch an outer surface of the string, the distance between calipers corresponds to the width or gauge of the string.

The system 102 may also include an input/output device, for example, a display operatively coupled to the electronic gauge 110. The input/output device may be configured to receive the first signal and output (e.g., display) the characteristic (e.g., the gauge or width) of the string to the user. In some embodiments, the first signal may additionally, or alternatively, be communicated to the user device 150. The user device 150 may be configured to interpret the first signal and output (e.g., display) the characteristic of the string of the musical instrument thereon.

In some embodiments, the system 102 may also include a tuner 140 configured to measure a frequency of one or more of the strings of the instrument. For example, the tuner 140 may be configured to determine when one or more strings of the instrument are strummed, determine a frequency of the one or more strings of the instrument in response to the one or more of the strings being strummed, and generate a second signal indicative of the frequency of the one or more strings. In some embodiments, the tuner 140 may include an acoustic tuner. For example, the tuner 140 may include a microphone disposed in the gauge body 130, for example, coupled to or included in the electronic gauge 110, and configured to receive acoustic signals in response a string of the instrument being strummed. The tuner 140 may be configured to interpret the acoustic signals and determine an acoustic frequency being generated by the one or more strings. In some embodiments, the frequency of the string measured by the tuner 140 may also be displayed on the input/output device of the electronic instrument (e.g., displayed on a display). In some embodiments the tuner 140 may also be configured to compare the measured acoustic frequency of the string with a desired frequency of the string and indicates to the user U when the measured frequency approximately matches the desired frequency. This can allow the user U to the tune the string, and thereby, the musical instrument to a desired frequency.

Expanding further, FIG. 2 shows a schematic block diagram of the electronic gauge 110, according to an embodiment. While electronic gauge 110 is shown to have certain components, these are for illustrative purposes only and any suitable electronic gauge capable of measuring the one or more characteristics of the strings as described herein may be included in the system 102. All such implementations are envisioned and should be considered to be within the scope of the present disclosure. As shown in FIG. 2, the electronic gauge 110 may include a power source 112, a memory 114, a processor 116, one or more calipers 118, an input/output device 124, a position sensor 120, and may optionally, also include an engagement mechanism 122, and a communication interface 125. In some embodiments, the tuner 140 may also be included in the electronic gauge 110.

The power source 112 may include a disposable or rechargeable battery (e.g., a Ni-Cad battery, a lithium ion battery, alkaline battery, carbon zinc battery, etc.) configured to provide electrical power to the various components of the electronic gauge 110. The power source 112 may have any suitable form factor, for example, a coin cell, a AA battery, a AAA battery, a D-cell, or any other suitable shape or form factor. In some embodiments, the power source 112 may be removably disposed in the gauge body 130 as described herein. The power source 112 may be accessible by removing a power source cover coupled to the gauge body 130.

The memory 114 can be any suitable memory device(s) configured to store data, information, computer code or instructions (such as those described herein), and/or the like. In some embodiments, the memory 114 can be and/or can include one or more of a random access memory (RAM), static RAM (SRAM), dynamic RAM (DRAM), a memory buffer, an erasable programmable read-only memory (EPROM), an electrically erasable read-only memory (EEPROM), a read-only memory (ROM), flash memory, volatile memory, non-volatile memory, combinations thereof, and the like. In some embodiments, the memory 114 can store instructions to cause the processor 116 to execute modules, processes, and/or functions associated with the electronic gauge 110 or the system 102, such as models, calculations, or other algorithms to analyze the position of the position sensor and determine the spacing between the calipers to determine gauge or width of the string, or to analyze signals received from the tuner 140 to determine a frequency of vibration or acoustic frequency of one or more strummed strings, etc. In some embodiments, the memory 114 may also be configured to at least temporarily store string gauge or width data, and/or tuner data, for example, until the data is transmitted to the user device 150 via the network 105 or the cloud.

The processor 116 can be any suitable processing device(s) configured to run and/or execute a set of instructions or code. For example, the processor 116 can be and/or can include one or more data processors, programmable logic units, processors, physics processing units, digital signal processors (DSP), analog signal processors, mixed-signal processors, machine learning processors, deep learning processors, finite state machines (FSM), compression processors (e.g., data compression to reduce data rate and/or memory requirements), encryption processors (e.g., for secure wireless data and/or power transfer), and/or the like. The processor 116 can be, for example, a general-purpose processor, central processing unit (CPU), microprocessor, microcontroller, Field Programmable Gate Array (FPGA), an Application Specific Integrated Circuit (ASIC), a processor board, a virtual processor, and/or the like. The processor 116 can be configured to run and/or execute application processes and/or other modules, processes and/or functions associated with the electronic gauge 110 or the system 102. The underlying device technologies may be provided in a variety of component types, for example, metal-oxide semiconductor field-effect transistor (MOSFET) technologies like complementary metal-oxide semiconductor (CMOS), bipolar technologies like generative adversarial network (GAN), polymer technologies (e.g., silicon-conjugated polymer and metal-conjugated polymer-metal structures), mixed analog and digital, and/or the like. In some embodiments, the processor 116 can be configured to receive data from the position sensor 120 coupled to the calipers 118, the input/output device 124, the communication interface 125, or the tuner, and to process that data, for example, to determine the string characteristic (e.g., string gauge, width, frequency, etc.). Alternatively or additionally, the processor 116 can be configured to send data from the position sensor 120, the tuner 140, or other components of the electronic gauge 110 to the user device 150, or any other remote device via the network 105, for storage and/or for further processing and/or analysis.

The communication interface(s) 125 can be any suitable device(s) and/or interface(s) that can communicate with one or more components of the electronic gauge 110 (e.g., the processor, the position sensor 120, the tuner 140, the communication interface 125, etc.), a network (e.g., a local area network (LAN), a wide area network (WAN), or the cloud), or an external device (e.g., the user device 150 such as cell phone, tablet, a laptop, or a desktop computer, etc.). Moreover, the communication interface(s) 125 can include one or more wired and/or wireless interfaces, such as, for example, Ethernet interfaces, optical carrier (OC) interfaces, and/or asynchronous transfer mode (ATM) interfaces. In some embodiments, the communication interface(s) 125 can be, for example, a network interface card and/or the like that can include at least an Ethernet port and/or a wireless radio (e.g., a WI-FI® radio, a BLUETOOTH® radio, cellular such as 3G, 4G, 5G, etc., 802.11X Zigbee, etc.). In some embodiments, the communication interface(s) 125 can include one or more satellite, WI-FI, BLUETOOTH, or cellular antenna. In some embodiments, the communication interface(s) 125 can be communicably coupled to an external device (e.g., an external processor) that includes one or more satellite, WI-FI®, BLUETOOTH®, or cellular antenna, or a power source such as a battery or a solar panel. In some embodiments, the communication interface(s) 125 can be configured to receive the first signal corresponding to a string characteristic such as a string gauge or width, and/or the second signal corresponding to the acoustic frequency of one or more strummed strings, or firmware/software update signals. In some embodiments, the communications interface(s) 125 may also be configured to communicate the first signal, the second signal, or any other information to the user device 150.

The input/output (I/O) device(s) 124 may include any suitable device to receive input from a user U (e.g., activate the electronic gauge 110, deactivate the electronic gauge, turn ON/OFF, record and/or store measurement, switch between gauge, width, or frequency measuring modes, etc.) or communicate an output to the user U and/or user device 150 (e.g., via the communication interface 125). In some embodiments, the I/O device(s) 124 may include an activation mechanism or otherwise, a user actuated element (e.g., a touch button, a push button, a switch, a touchpad, etc.) to turn on or otherwise, activate the electronic gauge 110, the tuner 140, initiate the measurement of one or more string characteristics, and/or to allow the user U to enter information, request information, or set various parameters of the electronic gauge 110 (e.g., begin measurement, stop measurement, communicate measurement, turn ON, turn OFF). In some embodiments, the I/O device(s) 124 may include a visual indicator (e.g., LED lights, a display, etc.) to display information to the user U. For example, the I/O device 124 may include a display operatively coupled to the electronic gauge 110 and configured to display to the user the measured characteristic of the string (e.g., the width of the string in response to receiving the first signal, the frequency of the string in response to receiving the second signal, date, time, musical instrument type, make, and/or model, power source state of charge, connectivity status such as WIFI® connectivity status, any other suitable information or a combination thereof).

As previously described, the electronic gauge 110 may include one or more calipers 118, for example, a pair of calipers 118 extending from the electronic gauge 110 into the string opening. In embodiments in which the calipers 118 includes a pair of calipers 118, at least one of the pair of calipers 118 may be configured to be moved relative to the other of the pair of calipers to receive the string therebetween (i.e., the string of the musical instrument disposed in the string opening).

Expanding further, in some embodiments, the caliper(s) 118 may include a pair of calipers 118 that include longitudinal leg like elements having a base disposed in the gauge body 130 and a tip protruding into the string opening defined by the gauge body 130. In some embodiments, one of the pair of calipers 118 may be a fixed caliper disposed fixedly in gauge body 130. The other one of the pair of calipers 118 may be a movable caliper that is movable or displaceable relative to the fixed caliper to increase a spacing therebetween so as to allow a string to be disposed between the tips of the calipers. In some embodiments, the movable caliper may have a length that is longer than a length of the fixed caliper. In some embodiments, the fixed caliper may be excluded and an inner surface of a wall of the string opening may serve to provide a fixed support such that the string can be engaged between the inner surface of the wall of the string opening and the movable caliper during measurement. In some embodiments, the tips of the caliper(s) 118 (e.g., each of the fixed caliper and the movable caliper) may be rounded, or formed and/or coated with a soft and flexible material to prevent damage to the instrument during measurement. For example, the tip of the caliper(s) 118 may inadvertently contact a surface of the musical instrument below the string being measured. Making the tips of the caliper(s) 118 rounded may inhibit scratching of, or otherwise damage to the surface of the musical instrument.

A portion of the caliper, for example, a base of the caliper(s) 118 located distal from the string opening of the gauge body 130 is operatively coupled the position sensor 120. In some embodiments, the caliper(s) 118 include a fixed caliper and a movable caliper, and a base of the movable caliper is coupled to the position sensor 120. In some embodiments, each of the pair of calipers 118 may include movable calipers capable of moving (e.g., sliding or moving laterally) relative to one another to enable a string to be disposed therebetween, for example, between their respective tips). For example, the base of at least the movable caliper may be mounted on or otherwise movably coupled to a rail, a slider bar, a slider-crank mechanism, a rack and pinion mechanism, or any other suitable displacement mechanism that is configured to enable least the movable caliper to be displaced (e.g., slid or moved) relative to the fixed caliper. In some embodiments in which each of a pair of calipers are movable, a base of each of the calipers may be mounted on or movably coupled to the displacement mechanism (e.g., a rail or bar), allowing each of the calipers to be displaced away from, or towards each other along the rail so as to enable the string to be removably received therebetween (e.g., between the tips thereof).

The position sensor 120 may include any suitable sensor configured to sense, measure, or determine a position of the caliper(s) 118, for example, the movable caliper relative to the fixed caliper, and generate the first signal indicative of the position that corresponds to the string characteristic (e.g., the string gauge or width). The position sensor 120 may include, but is not limited to a capacitive displacement sensor, an eddy current sensor, a hall effect sensor, an inductive sensor, a laser doppler vibrometer, a linear variable differential transformer, a photodiode array, a potentiometer, a proximity sensor, a string potentiometer, an ultrasonic sensor, a liner encoder, any other position sensor, or any suitable combination thereof. As described herein, a base of at least the movable caliper is movably coupled to the displacement mechanism (e.g., a rail), and also operably coupled to the position sensor 120 such that when at least the movable caliper is displaced (e.g., slid) along the displacement mechanism, the position sensor 120 senses, detects, or measures the position of the movable caliper (e.g., amount of displacement relative to its initial position), and generates a position sensor signal corresponding to its position or displacement. The processor 116, and/or the user device 150, may be configured to receive the first signal and interpret the first signal to determine the amount of displacement of the movable caliper, or distance between the calipers 118. The processor 116 may further be configured to determine the string characteristic based on the amount of distance or displacement, and generate the first signal indicative of the string characteristic. The first signal may be communicated to the I/O device 124 (e.g., a display) and/or the user device 150, for indicating the string characteristic to the user U.

The electronic gauge 110 may also include an engagement mechanism 122 configured to allow the user U to engage the caliper(s) 118, for example, to move the movable caliper relative to the fixed caliper to allow the string to be received between the tips of the caliper(s) or return the movable caliper to an initial position once the string is removed from the string opening. In some embodiments, the engagement mechanism 122 may include a slider coupled to at least one of the pair of calipers 118. The slider may be configured to be engaged by the user U to displace at least one of the pair of caliper(s) 118 relative to the other of the pair of caliper(s) 118, or alternatively, displace each of the pair of calipers 118 towards or away from each other, to allow the string to be disposed between the pair of caliper(s) 118. The slider may include, for example, a protrusion, a projection, a tab, a lever, or any other suitable feature or structure that is accessible to the user U through a corresponding opening in the gauge body 130, and can be engaged by the user U to displace the caliper(s) 118, for example, at least one of a pair of calipers. For example, the gauge body 130 may define a linear slot or opening through which at least a portion of the engagement mechanism 122 (e.g., the slider) projects out the gauge body 130, and is engageable by the user U.

In operation, in a first configuration, the tips of the caliper(s) 118 or a tip of a caliper and corresponding edge of the string opening may be in contact with each other. The first configuration may correspond to distance of about zero between the calipers, or an initial position of the caliper(s) 118. In some embodiments, the electronic gauge 110 may be configured to receive a calibration signal (e.g., from the user U via the I/O device 124) indicative of the caliper(s) 118 being in the first configuration or initial position. To measure the characteristic of the string, the user U may move at least the movable caliper relative to the fixed caliper via the engagement mechanism 122 to move the electronic gauge 110 into a second configuration in which a distance or gap between the tips of the calipers 118 is increased allowing the string to be received therebetween when the string is inserted in the string opening. Once the string is in the string opening, at least the movable caliper may be moved towards the fixed caliper until tips of each of the caliper(s) 118 touch opposing surfaces of the string. In this configuration, the output of the position sensor 120 (e.g., output or displayed on the I/O device 124 and/or the user device 150) corresponds to the string characteristic (e.g., the string gauge or width). The string may then be removed from the string opening and the caliper(s) 118 may be returned to the first configuration by the user U via the engagement mechanism 122. In some embodiments, a biasing member (not shown in FIG. 2), for example, a spring (e.g., a helical spring, a coil spring, a leaf spring, a Belleville spring, etc.) may be coupled to the movable caliper and configured to urge the pair of caliper(s) 118 towards each other to secure the string between the pair of caliper(s) 118. The biasing member may be configured to urge the movable caliper towards the string and/or back into the first configuration.

In some embodiments, the tuner 140 may be included in the electronic gauge 110. In other embodiments, the tuner 140 may be a separate component from the electronic gauge 110 and may be communicatively coupled to the electronic gauge 110. In some embodiments, the I/O device 124 may be configured to allow the user U to input a signal indicating to the system 102 to measure frequency, or string gauge or width. To measure the frequency of the one or more strings, the system 102 may be disposed proximate to the musical instrument or on the instrument (e.g., clipped to the neck of a guitar), and one or more strings strummed allowing the tuner 140 to sense or detect the acoustic frequency or vibrational frequency of the one or more strummed strings, and generate the second signal indicative of the frequency, as previously described herein.

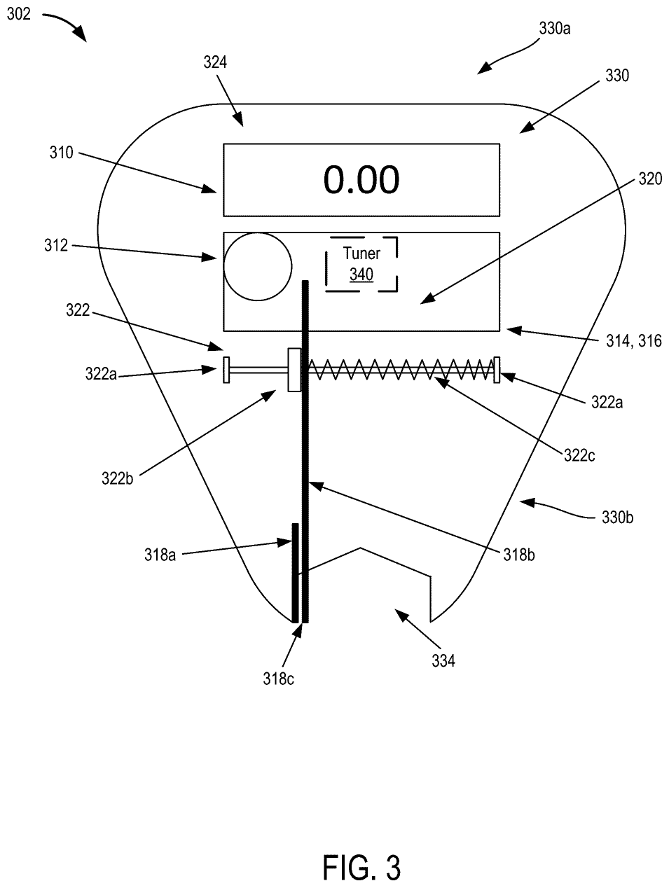

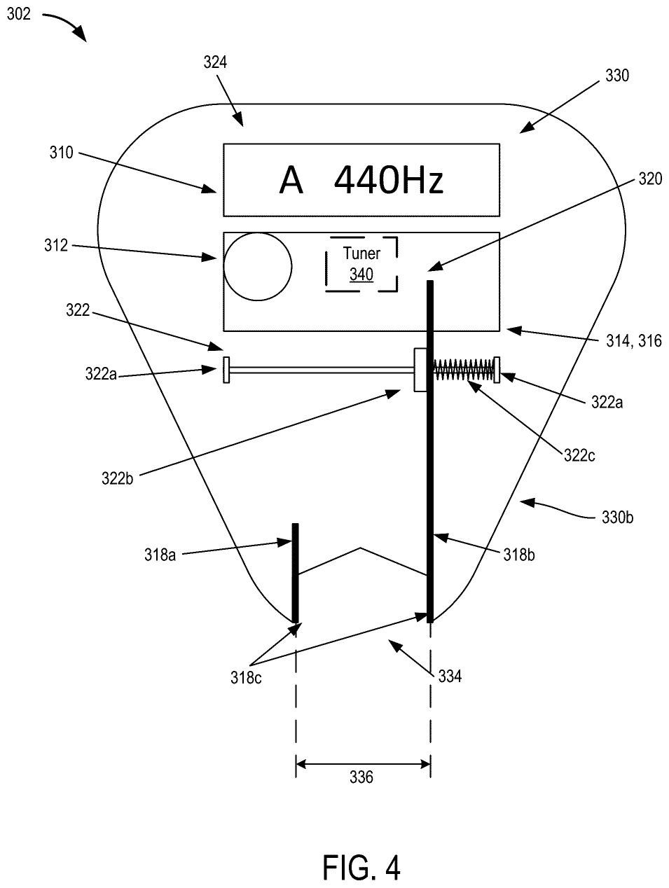

FIG. 3 is an illustration of a string measurement system 302 (hereinafter “system 302”) in a first configuration, and FIG. 4 is an illustration of the system 302 in a second configuration, according to an embodiment. In some embodiments, the string measurement system 302 may be included in the system 100 and may be communicatively coupled to the user device 150, as previously described herein. As shown in FIGS. 3-4, the system 302 may include an electronic gauge 310 coupled to or disposed at least partially within a gauge body 330. In FIGS. 3 and 4, a portion of the gauge body 330 is removed to show the components of the electronic gauge 310. In some embodiments, the system 302 may also include a tuner 340, for example, included in, or coupled to the electronic gauge 310. The electronic gauge 310 may be configured to measure a characteristic, for example, a first characteristic of one or more strings of a musical instrument (e.g., a gauge or width), and the tuner 140 may be configured to measure a second characteristic of the one or more strings of the musical instrument that is different from the first characteristic, for example, a frequency of the one or more strings. The tuner 340 may be substantially similar to the tuner 140 and therefore, not described in further detail herein.

The gauge body 330 may include a housing that may have one more portions configured to be coupled together to define an internal volume within which at least a portion of the electronic gauge 310 may be disposed. As shown in FIGS. 3-4, the gauge body 330 is shaped as a guitar pick. In other embodiments, the gauge body 330 may have any suitable shape, for example, an oblong shape, an oval shape, a triangular shape, or an asymmetrical shape. The gauge body 330 has a proximate portion 330a configured to be engaged (e.g., held or gripped) by a user, and a distal portion 330b configured to engage the string of the instrument. The proximate portion 330a may have a first width that is larger than a second width of the distal portion. In other words, the proximate portion 330a may be larger than the distal portion. The gauge body 130 may have rounded corners and or edges, for example, to prevent damage such as scratches to the musical instrument, and/or the user when being used. In some embodiments, the proximate portion 330a may include engagement features, for example, grooves, indents, detents, ribs, etc., to enhance a grip of the user on the proximate portion. In some embodiments, at least the proximate portion 330a and/or the distal portion 330b may be formed from a soft material (e.g., plastics, rubberized plastic or metals, polymers, etc.) to facilitate gripping of the proximate portion, and/or damage the musical instrument during use.

The gauge body 330 includes a string opening 334 configured to receive a string of the instrument to allow the electronic gauge 310 to measure a characteristic of the string of the instrument (e.g., a gauge or width). The string opening 334 may include a slot or cut out defined or formed in the distal portion 330b of the gauge body 330. The string opening 334 may be shaped or sized to receive a string of the instrument. The string opening 334 may have a sufficient width to accommodate or receive the largest width (or diameter) string of the musical instrument such that smaller width (or diameter strings) of the musical instrument can also be received into the string opening 334. For example, the string opening 334 may have a width sufficient to receive each of strings E, A, D, G, B, and E of a guitar. In some embodiments, edges or the corner of the string opening 334 may be rounded, or formed, coated, and/or covered with a soft and flexible material to prevent damage to the musical instrument when the string is inserted into the string opening 334. For example, the user may grip the proximate portion 330a of the gauge body 330, and dispose the distal portion 330b of the gauge body 330 on the musical instrument such that a target string of the musical instrument is received within the string opening 334.

The gauge body 330 may include one or more openings to allow various portions of the electronic gauge 310 to be viewable or engageable by the user. For example, the gauge body 330 may include a front portion (not shown in FIGS. 3-4) that may define an input/output opening through which a display 324 (or an I/O output device such as the I/O device 124) included in the electronic gauge 310 may be viewable, accessible and/or engageable by the user U. In some embodiments, the front portion of the gauge body 330 may define an engagement opening configured to allow the user to access an engagement mechanism 322 included in the electronic gauge 310 and measure the characteristic of the string of the musical instrument, as described herein. In some embodiments, a plurality of slots may be defined in edges of the gauge body 130, for example, edges of the proximate portion 330a and configured to serve as a manual gauge, as described with respect to the system 102.

In some embodiments, the gauge body 330 may include a power source opening configured to receive a power source 312 (e.g., one or more coin cells, AA battery, AAA battery, D cell, rechargeable battery, etc.). A cover may be disposable and removably coupleable to the power source opening to allow a user to dispose in or remove the power source 312 from the power source opening. In some embodiments, a cover of the power source opening. For example, the power source 312 may include a coin cell, and the power source opening may include a circular opening configured to receive the coin cell for providing electrical power to the electronic gauge 310. In some embodiments, the cover may also be configured to serve as a manual gauge, for example, as described herein with respect to the manual gauge 336.

The electronic gauge 310 is configured to engage the string disposed in the string opening 334 to measure a characteristic (e.g., gauge or width) of the string, and a generate a first signal indicative of the characteristic. In some embodiments, the electronic gauge 310 may include a pair of calipers. The pair of calipers may include a fixed caliper 318a that is fixedly disposed in or coupled to the gauge body 130, and a movable caliper 318b configured to move relative to the fixed caliper 318a so as to allow the string to be received therebetween when the string is disposed in the string opening 334. For example, a tip 318c of each of the calipers 318a, 318b may extend into the string opening 334 and proximate ends of the calipers 318a, 318b may be disposed in the gauge body 330, for example, an internal volume defined by the gauge body 330. The proximate end of the movable caliper 318b may be coupled to a position sensor 320 that is configured to generate a first signal, for example, a current or voltage indicative of the spacing or distance between the tip 318c of the calipers 318a, 318b, or distance travelled by the movable caliper 318b relative to the fixed caliper 318a. When the string is disposed in the string opening 334 and the calipers 318a, 318b are disposed such that inner edges of the tips 318c of the calipers 318a, 318b touch an outer surface of the string, the distance between calipers 318a, 318b corresponds to the characteristic (e.g., width or gauge) of the string.

The electronic gauge 310 also includes the display 324. The display 324 may include an LED display, an LCD display, an e-ink display, a touch pad, any other suitable display, or any suitable combination thereof. In some embodiments, the display 324 may include an I/O device (e.g., the I/O device 124) configured to also receive inputs (e.g., from a user) and generate outputs, for example, visual, audio, and/or haptic outputs to communicate information to the user or a user device. In such embodiments, the display 324 may be configured to receive the first signal and output (e.g., display) the characteristic (e.g., the gauge or width) of the string to the user. In some embodiments, the first signal may be additional or alternatively communicated to the user device, as described herein.

The electronic gauge 310 may also include a memory 314, a processor 316, a position sensor 320, an engagement mechanism 322. In some embodiments, the tuner 340 may also be included in the electronic gauge 310, as described herein. The processor 316, and memory 314 may be included in an integrated electronic unit, for example, a printed circuit board, and may be substantially similar in structure and function to the processor 116, and memory 114, respectively. The power source 112 may include a disposable or rechargeable battery (e.g., a Ni-Cad battery, a lithium ion battery, alkaline battery, carbon zinc battery, etc.) configured to provide electrical power to the various components of the electronic gauge 310. In some embodiments, the electronic gauge 310 may also include a communication interface (e.g., the communication interface(s) 125, as described herein) that may be configured to communicate with a user device (e.g., the user device 150).

Each of the calipers 318a, 318b longitudinal leg like elements having a base disposed in the gauge body 330 and a tip 318c protruding into the string opening 334 defined by the gauge body 330. As shown in FIGS. 3-4, the movable caliper 318b may have a length that is longer than a length of the fixed caliper 318a. In some embodiments, the fixed caliper 318a may be excluded and an inner surface of the wall of the gauge body 330 in which the string opening 334 is defined may serve as the fixed support such that the string can be engaged between corresponding inner surfaces of the wall and the movable caliper 318b during measurement. In some embodiments, the tips 318c of the calipers 318a, 318b may be rounded, or formed and/or coated with a soft and flexible material to prevent damage to the instrument during measurement. For example, the tip 318c of the calipers 318a, 318b may inadvertently contact a surface of the musical instrument below the string being measured. Making the tips 318c of the calipers 318a, 318b rounded may inhibit scratching or denting the surface of the musical instrument.

The electronic gauge 310 may also include an engagement mechanism 322 configured to allow the user U to engage the movable caliper 318b so as to move the movable caliper 318b relative to the fixed caliper 318a. This allows the string to be received between the tips 318c of the caliper 318a, 318b or return the movable caliper 318b to an initial position, for example, a first configuration shown in FIG. 3 once the string is removed from the string opening 334. As shown in FIG. 3, the engagement mechanism 322 may include a rail 322a. A base of the movable caliper 318b may be movably coupled to a rail 322a, and also operably coupled to the position sensor 320. As the movable caliper 318b is displaced (e.g., slid) along the rail 322a, the position sensor 320 senses, detects, measures, or determines the position of the movable caliper 318b (e.g., amount of displacement relative to its initial position, a relative position, or absolute position), and generates a position sensor signal corresponding to the position or displacement of the movable caliper 318b. The position sensor 320 may include any suitable sensor configured to sense, detect, measure, or determine a position of the movable caliper 318b relative to the fixed caliper 318a, and generate the first signal indicative of the string characteristic (e.g., the string gauge or width). The position sensor 320 may be substantially similar in structure and function to the position sensor 120 and therefore, not described in further detail herein. The processor 316 may be configured to receive the first signal and interpret the first signal to determine the amount of displacement or distance between the tips 318c of the calipers 318a, 318b. The processor 316 may further be configured to determine the string characteristic based on the amount of distance or displacement, and generate the first signal that may be communicated to the display 324 and/or a user device, for indicating the string characteristic to the user.

The engagement mechanism 322 may also include a slider 322b coupled to the movable caliper 318b. The slider 322b is configured to be engaged by the user to displace the movable caliper 318b relative to the fixed caliper 318a to allow the string to be disposed between the pair of calipers 318a, 318b. The slider 322b may include, for example, a protrusion, a projection, a tab, a lever, or any other suitable features that is accessible to the user through a corresponding opening in the gauge body 330. The slider can be engaged by the user to displace the movable caliper 318b relative to the fixed caliper 318a along the rail 322a. In some embodiments, the engagement mechanism 322 may also include a biasing member 322c, for example, a spring (e.g., a helical spring, a coil spring, a leaf spring, a Belleville spring, etc.) may be coupled to the movable caliper 318b and configured to urge the movable caliper 318b towards the fixed caliper 318a to secure the string between the calipers 318a, 318b, or return the movable caliper 318b to the first configuration once the string is removed from the string opening 334.

In operation, in the first configuration shown in FIG. 3, the tips 318c of the calipers 318a, 318b may be in contact with each other. This may correspond to a distance of about zero between the calipers 318a, 318b, or an initial position of the calipers 318a, 318b. To measure the characteristic of the string, the user may move the system 302 into a second configuration shown in FIG. 4 by engaging the slider 322b and sliding the movable caliper 318b on the rail 322a away from the fixed caliper 318a such that a gap exists between the tips 318c of the calipers 318a, 318b in which the string can be inserted. Once the string is disposed in the string opening 334 between the tips 318c, the movable caliper 318b may be moved towards the fixed caliper 318a until tips 318c of each of the caliper 318a, 318b touch opposing surfaces of the string. In this configuration, the output of the position sensor 320 (e.g., output or displayed on the display 324 and/or communicated to a user device) corresponds to the string characteristic (e.g., the string gauge or width). The string may then be removed from the string opening 334 and the movable calipers 318b may be returned to the first configuration by the user by engaging the slider 322b, or urged into the first configuration by the biasing member 322c.

In some embodiments, the tuner 340 may be included in the electronic gauge 310. In some embodiments, the display 324 or another I/O device may be configured to allow the user to input a signal indicating to the system 302 to selectively measure frequency via the tuner 340, or measure the string gauge or width via the calipers 318a, 318b. To measure the frequency of the one or more strings, the system 302 may be disposed proximate to the musical instrument or on the instrument (e.g., clipped to the neck of a guitar), and one or more strings strummed allowing the tuner 340 to sense or detect the acoustic frequency or vibrational frequency of the one or more strummed strings, and generate a second signal indicative of the frequency. The second signal may be communicated to the display 324 to display the detected frequency of the one or more strummed strings on the display 324, as shown in FIG. 4.

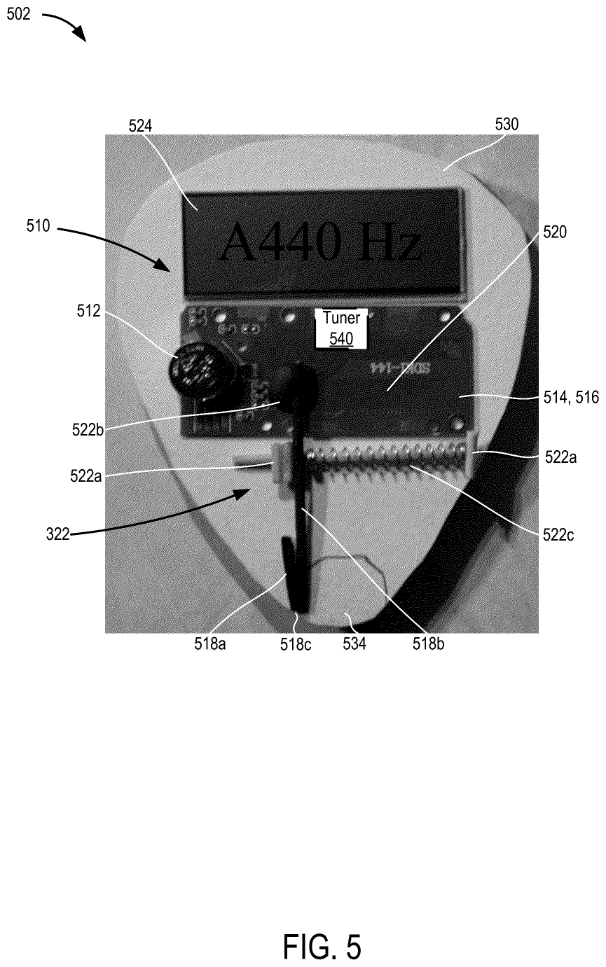

FIG. 5 is an illustration of a string measurement system 502 in a first configuration, according to an embodiment. The string measurement system 502 may be included in the system 100 or any other string measurement system. In some embodiments, the system 502 may be communicatively coupled to a user device (e.g., the user device 150), as previously described herein. The system 502 may include an electronic gauge 510 coupled to a gauge body 530 (e.g., at least partially disposed within the gauge body 530). A portion of the gauge body 530 is removed in FIG. 5 to show the components of the electronic gauge 510. In some embodiments, the system 502 may also include a tuner 540, for example, included in, or coupled to the electronic gauge 510. The electronic gauge 510 may be configured to measure a characteristic, for example, a first characteristic of one or more strings of a musical instrument (e.g., a gauge or width), and the tuner 540 may be configured to measure a second characteristic of the one or more strings of the musical instrument that is different from the first characteristic, for example, a frequency of the one or more strings. The tuner 540 may be substantially similar to the tuner 540 and therefore, not described in further detail herein.

The gauge body 530 may include a housing that may have one more portions configured to be coupled together to define an internal volume within which at least a portion of the electronic gauge 510 may be disposed. As shown in FIG. 5, the gauge body 530 is shaped as a guitar pick having rounded corners. The gauge body 530 includes a string opening 534 configured to receive a string of the instrument. The string opening 534 may include a slot or cut out defined or formed in the distal portion 530b of the gauge body 530. The string opening 534 may be shaped or sized to receive a string of the instrument to allow the electronic gauge 510 to measure a characteristic of the string of the instrument (e.g., a gauge or width). The gauge body 530 may include one or more openings to allow various portions of the electronic gauge 510 to be viewable or engageable by the user, for example, defined in a front portion of the gauge body 530 (not shown in FIG. 5). In some embodiments, the gauge body 530 may define a power source opening configured to receive a power source 512, for example a coin cell as shown in FIG. 5. A cover may be disposable and removably coupleable to the power source opening to allow a user to dispose in or remove the power source 512 from the power source opening. The gauge body 530 may be substantially similar to the gauge body 330 and therefore, not described in further detail herein.

The electronic gauge 510 is configured to engage the string disposed in the string opening 534 to measure a characteristic (e.g., gauge or width) of the string, and a generate a first signal indicative of the characteristic. The electronic gauge 510 includes a pair of calipers including a fixed caliper 518a that is fixedly coupled to (e.g., fixedly disposed in) the gauge body 530, and a movable caliper 518b configured to move relative to the fixed caliper 518a to allow the string to be received between tips 318c of the calipers 318a, 318b when the string is disposed in the string opening 534. Tips 518c of the calipers 518a, 518b may extend into the string opening 334 and proximate ends of the calipers 518a, 518b may be disposed in the gauge body 530. The calipers 518a, 518b may be substantially similar in structure and function to the calipers 318a, 318b and therefore, not described in further detail herein.

The system 502 (e.g., the electronic gauge 510) also include the display 524 operatively coupled to the electronic gauge 510, which in some embodiments, may include an I/O device (e.g., the I/O device 124) configured to also receive inputs (e.g., from a user) and generate outputs, for example, visual, audio, and/or haptic outputs to communicate information to the user or a user device. The electronic gauge 510 may also include a memory 514, a processor 516, a position sensor 520, an engagement mechanism 522. In some embodiments, the tuner 540 may also be included in the electronic gauge 510, as previously described herein. The processor 516, and memory 514 may be included in an integrated electronic unit, for example, a printed circuit board, and may be substantially similar in structure and function to the processor 116, and memory 114, respectively. In some embodiments, the electronic gauge 510 may also include a communication interface (e.g., the communication interface(s) 125, as described herein) that may be configured to communicate with a user device (e.g., the user device 150).

The electronic gauge 510 also includes an engagement mechanisms 522 operatively coupled to at least the movable caliper 518b, and a position sensor 520 configured to sense, measure, determine, or detect a position of the movable caliper 518b, for example, a relative distance or spacing between the fixed caliper 518a, and the movable caliper 518b. The engagement mechanism 522 may include a rail 522a, a slider 522b, and a biasing member 522c operatively coupled to at least he movable caliper 518b.

A base of the movable caliper 518b is movable coupled to the rail 522a, and also operably coupled to the position sensor 520 such that as the movable caliper 518b is displaced (e.g., slid) along the rail 522a, the position sensor 520 senses, detects, or measures the position of the movable caliper 518b (e.g., amount of displacement relative to its initial position), and generates a position sensor signal corresponding to the position or displacement. The engagement mechanism 522, and the position sensor 520 may be substantially similar to the engagement mechanism 322 and position sensor 320 and therefore, not described in further detail herein.

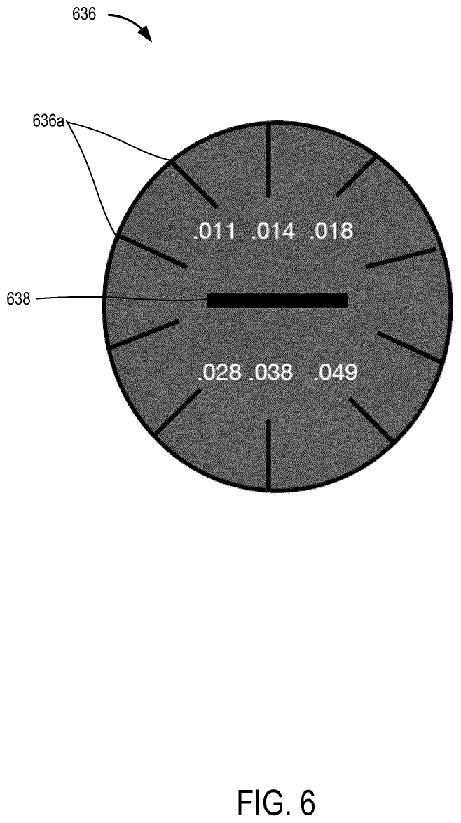

FIG. 6 is an illustration of a power source cover 636 that may be included in any of the string measurement instruments described herein, according to an embodiment. The power source cover 636 includes a circular cover configured to be removably coupled to a power source opening defined in a gauge body (e.g., the gauge body 130, 330, or 530) of a string measurement instrument, which is configured to receive a coin cell. For example, the power source cover 636 may include threads, or protrusions defined on an outer periphery of at least a portion thereof, which are configured to engage corresponding features (e.g., mating threads, ledge(s), etc.) in the power source opening to allow the power source cover 636 to be removably coupled to the gauge body. A notch 638 (e.g., a longitudinal slit) may be defined in a portion of the power source cover 636. The notch 638 may be configured to be engaged by a user, for example, by a user's thumb nail, or a tip of a flat screw driver for coupling or uncoupling the power source cover 636 to the gauge body.

The power source cover 636 includes or defines a plurality of slots 636a around a periphery of the power source cover 636. Each slot 636a of the plurality of slots 636a may define a width that is different from the width of the other slots 636a of the plurality of slots 636a. Each slot 636a is configured to receive a string of an instrument having a width that is less than or equal to the width of the respective slot 636a. If the width of the string inserted into a particular slot 636a approximately matches or is equal to the width of the particular slot 636a (e.g., inner edges of the particular slot 636a touch corresponding outer surfaces of the string on opposite sides of the string), the gauge or width or of the string can be approximated as being the gauge or width indicated by the particular slot 636a. In this manner, the user can engage the slots 636a with instrument strings to determine an approximate width of the instrument string. The widths of the plurality of slots 636a can correspond to gauges that are commonly grouped together, such as strings for a particular instrument, standard instrument gauges, gauges used by a particular musician, and/or the like. In some embodiments, the power source cover 636 may be made from or coated with a soft or flexible material (e.g., formed or coated with plastics, polymers, rubbers, rubberized, etc.) to inhibit damage (e.g., scratching) of the instrument when using the power source cover 636 to determine the string gauge or width.

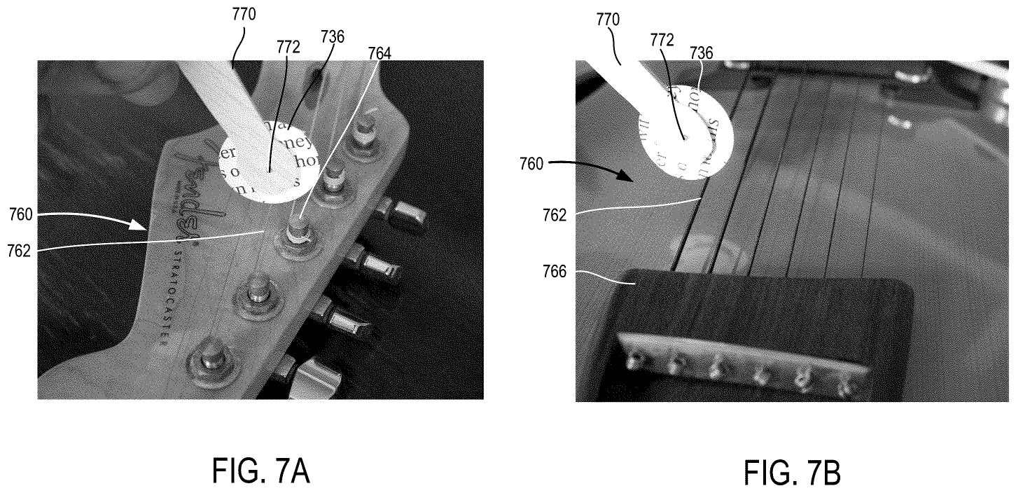

FIGS. 7A and 7B are illustrations of a power source cover 736 removed from a string measurement instrument and being used as a manual gauge to measure a width of strings 762 of a musical instrument 760 (e.g., guitar), according to an embodiment. The power source cover 736 includes a plurality of slots defining a width that is different from the width of the other slots of the plurality of slots and correspond to different widths or gauge of the various strings 762 of the instrument 760. In some embodiments, the power source cover 736 may be configured to be mounted on a manual gauge mount 770 to facilitate a user in employing or using the power source cover 736 as a manual gauge. For example, the manual gauge mount 770 may include an elongated member having a proximate end configured to be engaged or held by a user when making manual gauge measurements, and a distal end that includes a mount on which the power source cover 736 can be mounted, for example, rotatably mounted, for making manual measurements. In some embodiments, the mount may include a pin 772 configured to removably mate with a corresponding slot, opening, or receptacle defined in the power source cover 736. However, any suitable mounting mechanism that allows the power source cover 736 to be mounted on the manual gauge mount 770, for example, rotatably mounted thereon, may be used.

In use, the user may grip the manual gauge mount 770 at a proximate end thereof, and rotate the power source cover 736 to orient a desired slot thereof towards a string 762 whose gauge or width is being determined. The user may then urge the respective slot around the string 762 until the string 762 is inserted therein. If an inner width of the slot approximately matches the outer width of the string, then the slot width or gauge is indicative of the width or gauge of the string 762. If this is not the case, the user can rotate the power source cover 736 to position another slot towards the string 762 to repeat the process. The power source cover 736 can be used to manually measure the gauge or width of the string(s) 762 at any suitable location on the musical instrument 760. For example, FIGS. 7A-7B show the musical instrument 760 as being a guitar, and the power source cover 736 can be used to measure the string 762 gauge or width near tuning pegs 764 of the guitar as shown in FIG. 7A, or near a bridge 766 of the guitar.

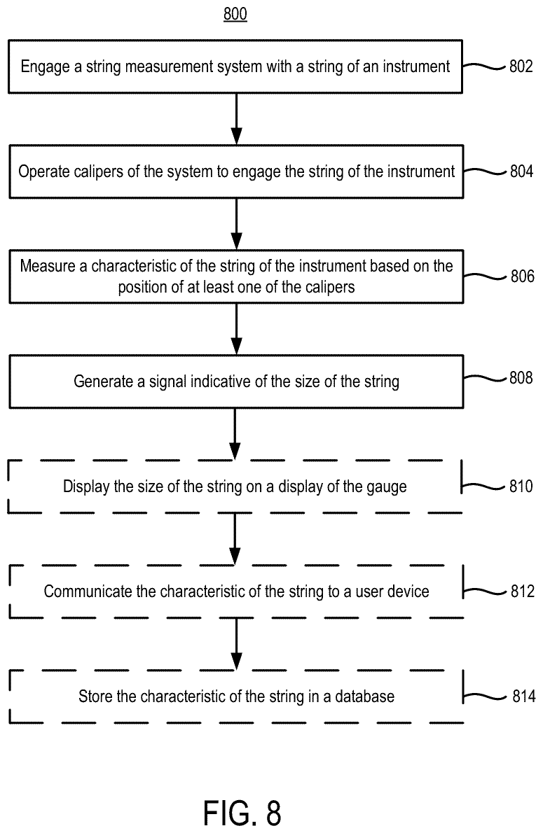

FIG. 8 is a schematic flow diagram of a method 800 for determining a width or gauge of a string using a string measurement system (e.g., the string measurement system 102), according to an embodiment. While described with respect to the string measurement system 102 and the components thereof, the method 800 is equally applicable to any of the string measurement systems described herein. All such implementations are contemplated and should be considered to be within the scope of this disclosure.

The method 800 may include engaging the string measurement system 102 with a string of an instrument, at 802. For example, the user may insert the string into the string opening defined by the gauge body 130 of the string measurement system 102 to engage the string. At 804, the caliper(s) 118 of the system 102 are operated to engage the string of the instrument For example, the caliper(s) 118 may be in a disposed in a position such that gap exists between corresponding tips of the caliper(s) 118. Once the string is disposed in the string opening, the user may engage a slider of the system 102 to move the caliper(s) 118, for example, the movable caliper such that the inner surfaces or edges of the caliper(s) 118 contact corresponding outer surfaces of the string.

At 806, a characteristic, for example, gauge or width, of the string of the instrument is measured based on the position of at least one caliper 118 of the caliper(s) 118 of the system 102. For example, the base of the movable caliper of the pair of caliper(s) 118 may be operatively coupled to the position sensor 120, and the position sensor senses, detects, or measures the position of the movable caliper which corresponds to characteristic of the string, as previously described herein. At 808, a first signal is generated by the position sensor 120, which is indicative of the characteristic, for example, gauge or width of the string, as previously described herein.

In some embodiments, the size of the string is displayed on the I/O device 124 (e.g., a display) of the electronic gauge 110, at 810. In some embodiments, the system 102 may optionally communicate the characteristic of the string to the user device 150, at 812, as previously described herein. In some embodiments, the method 800 may also include storing the characteristic of the string in a database or memory, at 814. The database or memory may be associated with at least one of the system 102, or the user device 150 (e.g. local database, remote database, the cloud, etc.) In some embodiments, the memory or database may also store other information associated with the instrument and/or the user, as previously described herein.

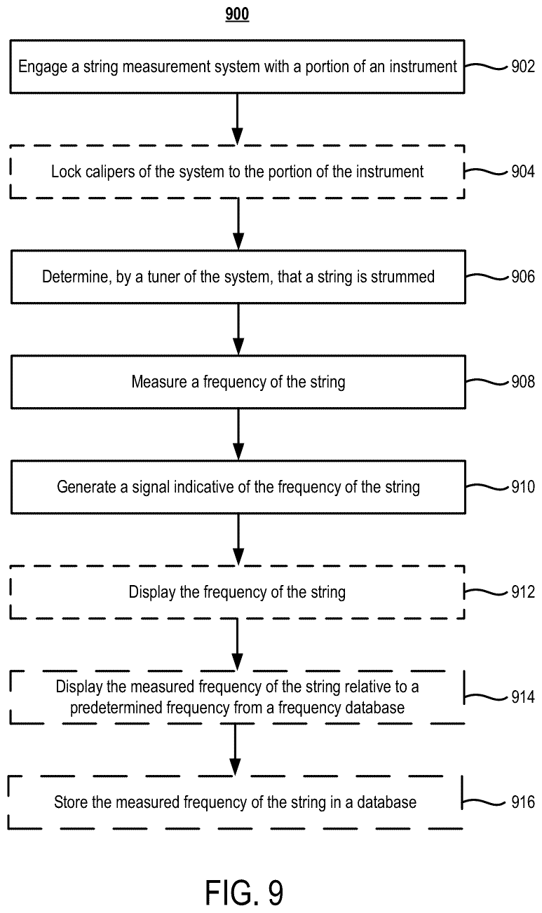

FIG. 9 is a schematic flow diagram of a method 900 for determining a frequency of a string of an instrument using a string measurement system (e.g., the system 102), according to an embodiment. While described with respect to the string measurement system 102 and the components thereof, the method 900 is equally applicable to any of the string measurement systems described herein. All such implementations are contemplated and should be considered to be within the scope of this disclosure.

The method 900 includes engaging a string measurement system 102 with a portion of a musical instrument, at 902. For example, the system 102 may be disposed proximate to the instrument, disposed on a base of the instrument (e.g., the base of a guitar), coupled to a neck of the instrument (e.g., the neck of a guitar via a capo or clip), or otherwise disposed at a location where the system 102 is in acoustic range of the instrument. In some embodiments, caliper(s) 118 of the electronic gauge 110 of the system 102 may be locked to or engaged with a string of the instrument, at 904. For example, the system 102 may be used to simultaneously measure a width of gauge of the string while measuring its frequency, as describe herein.

At 906, a tuner 140 of the system 102 may determine that a string of the instrument is strummed. For example, the tuner 140 may include a microphone or a vibration sensor configured to detect an acoustic or vibrational frequency, as described herein. At 908, a frequency of the string may be measured by the tuner 140, as described herein. At 910, the tuner 140 generates a signal (e.g. a second signal) indicative of frequency (e.g., acoustic or vibrational frequency) of the string. In some embodiments, the frequency of string may be displayed on the I/O device 124 (e.g., a display), at 912.

In some embodiments, the system 102 may also display the frequency of the string relative to a predetermined frequency from a string database, at 914. For example, the string database may store predetermined frequencies that correspond to desired or expected frequencies of various strings of the instrument. The system 102 (e.g., the processor) may display the measured frequency of the string relative to the predetermined frequency for that string on the I/O device 124. For example, the measured frequency may be displayed side by side as a number with the predetermined frequency, or displayed as a measured frequency wave overlaid on, or displayed side by side of the predetermined frequency for that string. While continuing to measure the frequency of the strummed string, the user may adjust the frequency of the string (e.g., by tightening or loosening the string via a corresponding tunning peg), until the measured frequency approximately matches the predetermined frequency, thus indicating to the user that the string is tuned. At 916, the measured frequency may be stored in a database, for example, the memory 114 of the electronic gauge 110, the user device 150, a remote memory, the cloud, etc.

The present disclosure is not limited in its application to the details of construction and the arrangement of components set forth in the preceding description or illustrated in the drawings. The present technology is capable of other embodiments and of being practiced or of being carried out in various ways. Also, the phraseology and terminology used herein is for the purpose of description and should not be regarded as limiting.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It should be noted that the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

The use of “including”, “comprising”, or “having”, “containing”, “involving” and variations thereof herein, is meant to encompass the items listed thereafter as well as, optionally, additional items. In the description the same numerical references refer to similar elements.

It must be noted that, as used in this specification and the appended claims, the singular form “a”, “an” and “the” include plural referents unless the context clearly dictates otherwise.

As used herein, the term “about” or “generally” or the like in the context of a given value or range (whether direct or indirect, e.g., “generally in line”, “generally aligned”, “generally parallel”, etc.) refers to a value or range that is within 20%, preferably within 10%, and more preferably within 5% of the given value or range.

As used herein, the term “and/or” is to be taken as specific disclosure of each of the two 10 specified features or components with or without the other. For example, “A and/or B” is to be taken as specific disclosure of each of (i) A, (ii) B and (iii) A and B, just as if each is set out individually herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first unit” and “third unit” is not intended to imply any particular type, hierarchy or ranking (for example) of/between the units. Nor is their use (by itself) intended to imply that any “second unit” must necessarily exist in any given situation.

As utilized herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled,” and the like as used herein mean the joining of two members directly or indirectly to one another. Such joining may be stationary (e.g., permanent) or moveable (e.g., removable, or releasable). Such joining may be achieved with the two members or the two members and any additional intermediate members being integrally formed as a single unitary body with one another or with the two members or the two members and any additional intermediate members being attached to one another.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and the like.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A string measurement system, comprising:
a gauge body including a string opening configured to receive a string of an instrument; and
an electronic gauge coupled to the gauge body, the electronic gauge configured to:
engage the string disposed in the string opening to measure a width of the string, and
generate a first signal indicative of the width.

2. The string measurement system of claim 1, further comprising:
a display operatively coupled to the electronic gauge, the display configured to display the width of the string in response to receiving the first signal.

3. The string measurement system of claim 1, wherein the electronic gauge includes a power source.

4. The string measurement system of claim 3, wherein the power source is a battery removably disposed in the gauge body.

5. The string measurement system of claim 3, further comprising:
a battery cover removably coupleable to the gauge body to allow the battery to be removably disposed in the gauge body, the battery cover including a plurality of slots, each of the plurality of slots defining a width that is different from the width of other slots of the plurality of slots, each slot of the plurality of slots configured to receive the string of the instrument having a width that is less than or equal to width of the respective slot to indicate to a user an approximate width of the string.

6. The string measurement system of claim 1, wherein:
the electronic gauge or the gauge body includes a locking mechanism, the locking mechanism configured to selectively couple a portion of the string measurement system to the instrument.

7. The string measurement system of claim 6, wherein the electronic gauge further comprises a tuner, the tuner configured to:
determine when one or more strings of the instrument are strummed,
determine a frequency of the one or more strings of the instrument in response to the one or more of the strings being strummed, and
generate a second signal indicative of the frequency of the one or more strings of the instrument.

8. The string measurement system of claim 7, further comprising a display operatively coupled to the electronic gauge, the display configured to display the frequency of the one or more string in response to receiving the second signal.

9. The string measurement system of claim 1, wherein the electronic gauge includes a pair of calipers, at least one of the pair of calipers configured to be moved relative to the other of the pair of calipers to receive the string therebetween to engage the string disposed in the string opening.

10. The string measurement system of claim 9, wherein a tip of each of the pair of calipers is rounded.

11. The string measurement system of claim 9, further comprising:
a slider operably coupled to at least one of the pair of calipers, the slider configured to be engaged to displace at least one of the pair of calipers relative to the other of the pair of calipers to allow the string to be disposed between the pair of calipers.

12. The string measurement system of claim 11, further comprising:
a biasing member configured to urge at least one of the pair of calipers towards the other of the pair of calipers to secure the string between the pair of calipers.

13. The string measurement system of claim 1, wherein the electronic gauge further comprises:
a communications interface configured to be communicatively coupled to a user device.

14. The string measurement system of claim 13, wherein the electronic gauge is configured to communicate the first signal to the user device.

15. The string measurement system of claim 1, wherein the gauge body is shaped as a guitar pick.

16. A string measurement system, comprising:
a gauge body defining a string opening configured to receive a string of a musical instrument;
a set of calipers supported by the gauge body, the calipers configured to at least partially protrude into the string opening;
a slider configured to enable movement of the set of calipers to cause the at least a portion of the set of calipers to engage with a string positioned in the string opening; and
a position sensor configured to determine position information associated with the calipers, the position information indicative of a width of the string positioned in the string opening.

17. The string measurement system of claim 16, wherein the gauge body is further includes a microphone, the microphone configured to:
sense an auditory signal in response to the string being strummed; and
transmit the sensed auditory signal to a tuner configured to determine an acoustic frequency of the string.

18. The string measurement system of claim 16, wherein the position information is indicative of a displacement between a first position and a second position of the set of calipers, the set of calipers configured to engage the string in the second position.

19. The string measurement system of claim 16, wherein the position sensor includes at least one of a capacitive displacement sensor, an eddy current sensor, a hall effect sensor, an inductive sensor, a laser doppler vibrometer, a linear variable differential transformer, a photodiode array, a potentiometer, a proximity sensor, a string potentiometer, an ultrasonic sensor, or a linear encoder.

20. A string measurement system, comprising:
a gauge body defining a string opening configured to receive a string of a musical instrument;
a position sensor coupled to the gauge body;
a tuner coupled to the gauge body;
a display coupled to the gauge body; and
a processor operably coupled to the position sensor and the tuner, the processor configured to:
determine a width of the string based on position data received from the position sensor;
determine an acoustic frequency associated with the string based on frequency data received from the tuner; and
communicate a signal indicative of at least one of the determined width and the acoustic frequency to the display.
